(19) United States
(12) Patent Application Publication
(10) Pub. No.: US 2002/0143702 A1
(43) Pub. Date: Oct. 3, 2002

(54) Method and apparatus for settling online prepaid transaction with optical disc

(76) Inventors: Hiu Hung Shek, Kowloon (CN); Ching Yuen Leung, Kowloon (CN)

Correspondence Address: TIMOTHY E SIEGEL, 1868 KNAPPS ALLEY, SUITE 206, WEST LINN, OR, 97068, US

(21) Appl. No.: 09/821,200

(22) Filed: Mar. 29, 2001

(51) Int. Cl. G06F 17/60

(52) U.S. Cl. 705/41

(57) ABSTRACT

A system for settling an online purchase made via an Internet connection to a online purveyor includes a central account platform connected to the Internet and a prepaid optical disc for use in a cd rom drive of the purchaser's computer. The account platform includes a database having multiple prepaid account records. Each of the prepaid account records has a unique prepaid account identifier and a monetary amount associated with the prepaid account identifier. The prepaid optical disc has one of the prepaid account identifiers and software recorded thereon. The software includes means for initiating communication between the account platform and the purchaser's computer.

### BACKGROUND OF THE INVENTION

The present invention relates generally to online systems for the sale of goods and services in an Internet environment. More particularly, the present invention relates to methods and apparatus implementing a prepaid transaction settlement system in an Internet environment.

Remote memory prepaid accounts for use in purchasing goods and services have been known for a long time. Typically, the information concerning such an account is recorded at a central host system and a transaction card having a unique authorization or account number printed thereon serves as the access key to update the information stored at the host system. To make a payment, the user enters the authorization number on the card into the host system, for example by touch-tone signals generated by the keypad of a telephone. After the authorization number is validated by the host system, the value of the transaction is deducted from the account. An example of such a system is a prepaid long distance calling card.

Another type of prepaid transaction settlement system utilizes stored-value cards. Typically, a stored-value card is a plastic card with magnetic strip or built-in smart chip on which the account information is stored. Since the account information is actually stored on the card, the stored information can be updated once the card is inserted into the appropriate reading device.

There are two types of conventional prepaid cards. The first is a fixed value prepaid card which has a pre-determined value. Once the user uses all the value stored in the account, the card becomes invalid and must be replaced with a newly purchased card. The second is a rechargeable prepaid card which will accept deposits to the account. Generally, such cards do not become invalid so long as deposits are made to the account.

Prepaid transaction settlement systems employing cards of the type discussed above are employed in wide variety of applications for both personal and professional use. For example, some academic institutions issue prepaid card for students for use in purchasing school and living supplies, booking sports facilities, and booking school facilities.

### SUMMARY OF THE INVENTION

Briefly stated, the invention in a preferred form is a system for settling an online purchase made via an Internet connection between a purchaser's computer and an online purveyor of goods or services. The system includes a central account platform connected to the Internet and a prepaid optical disc for use in a cd rom drive of the purchaser's computer. The account platform includes a database having multiple prepaid account records. Each of the prepaid account records has a unique prepaid account identifier and a monetary amount associated with the prepaid account identifier. The prepaid optical disc has one of the prepaid account identifiers and software recorded thereon. The software includes means for initiating communication between the account platform and the purchaser's computer.

The database of the account platform may also have multiple virtual value records, each of which includes a unique virtual value account identifier and a monetary amount associated with the virtual value account identifier. A virtual value card, for use in the cd rom drive of the purchaser's computer, has one of the virtual value account identifiers and software recorded thereon. The software includes means for initiating communication between the account platform and the purchaser's computer.

The system settles the online purchase by initiating communication between the purchaser's computer and the account platform. Once communication has been established, the prepaid account identifier stored on the prepaid optical disc is transmitted to the account platform. The account platform verifies account and purchase information and settles the purchase if the monetary amount associated with the prepaid account identifier is equal to or greater than the amount of the purchase.

An autorun program on the prepaid optical disc performs a validity check of the prepaid optical disc when the disc is inserted into the cd rom drive of the purchaser's computer in response to a request from an online purveyor of goods or services. After the disc has been verified, the autorun program initiates communication with the account platform. Thereafter, the purchaser's computer requests and receives algorithm information from the account platform and transmits the prepaid account identifier to the account platform. The account platform then interrogates the database to determine the monetary amount associated with the prepaid account identifier received from the purchaser's computer and queries the online purveyor for the amount of the purchase. If the monetary amount associated with the prepaid account identifier is greater than the amount of the purchase, the account platform transmits an approval code to the online purveyor. The account platform also transmits an authorization to a financial clearing house to transfer funds to the online purveyor. This authorization may be transmitted concurrently or at a later date and the transmission may occur via the internet or by traditional means. Finally, the account platform deducts the amount of the purchase from the monetary amount associated with the prepaid account identifier in the database and displays a transaction completed message on the purchaser's computer.

The monetary amount associated with the prepaid account identifier may be increased by inserting a prepaid optical disc into the cd-rom drive of the purchaser's computer. The software stored on the prepaid disc performs a validity check of the prepaid optical disc, initiates communication with the account platform, and downloads the prepaid account identifier. A virtual value card is inserted into the cd-rom drive of the purchaser's computer in response to a prompt from the account platform. The software stored on the virtual value card performs a validity check of the virtual value card and downloads the virtual value account identifier stored on the virtual value card. Alternatively, the virtual value card may be inserted before the prepaid optical disc, with the associated validity check and data download being performed as described above.

The account platform then interrogates the database to determine the monetary amount associated with the virtual value account identifier received from the purchaser's computer. Finally, the account platform adds the monetary amount associated with the virtual value card identifier to the monetary amount associated with the prepaid account identifier and zeros the monetary amount associated with the virtual value account identifier in the database.

It is an object of the invention to provide apparatus and methods for securely settling online purchases made over the Internet.

It is also an object of the invention to provide apparatus and methods for settling online purchases made over the Internet which have an inherently limited value.

Other objects and advantages of the invention will become apparent from the drawings and specification.

### BRIEF DESCRIPTION OF THE DRAWINGS

The present invention may be better understood and its numerous objects and advantages will become apparent to those skilled in the art by reference to the accompanying drawings in which:

FIG. 1 is schematic diagram illustrating an Internet system having a system for settling online purchases in accordance with the invention;

FIGS. 2a, 2b, and 2c are a flow diagram of a method of settling an online purchase in accordance with the invention; and

FIGS. 3a and 3b are a flow diagram of a method of making a deposit to a prepaid account in accordance with the invention.

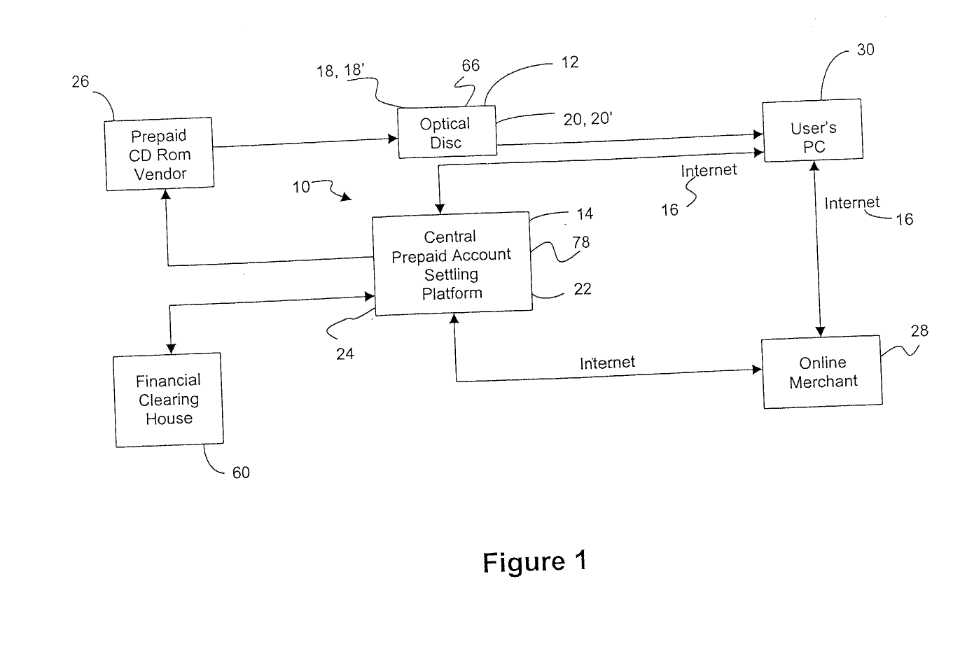

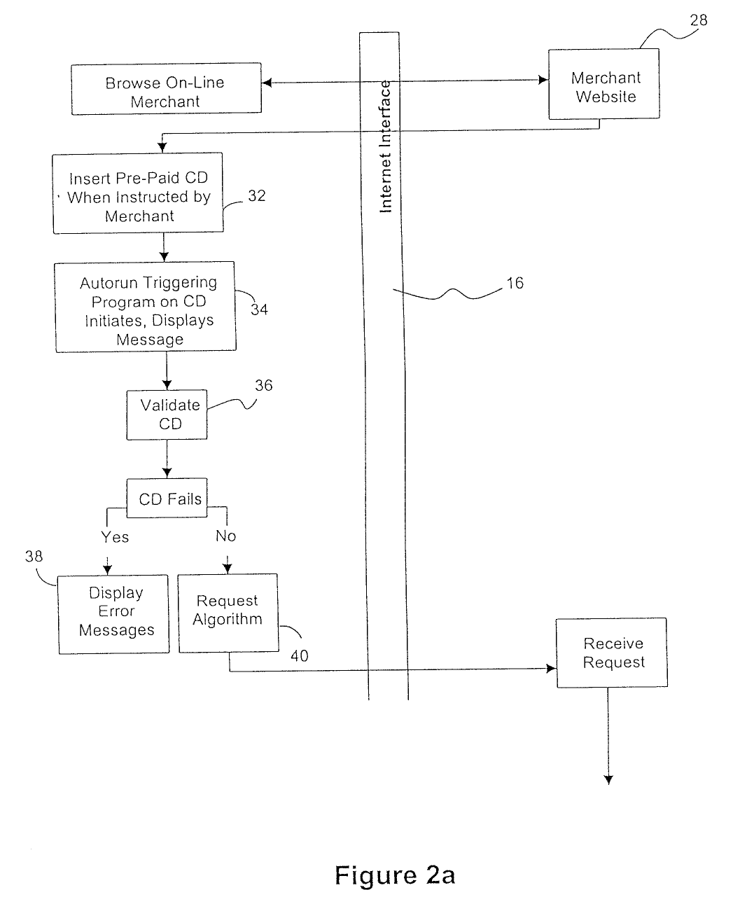

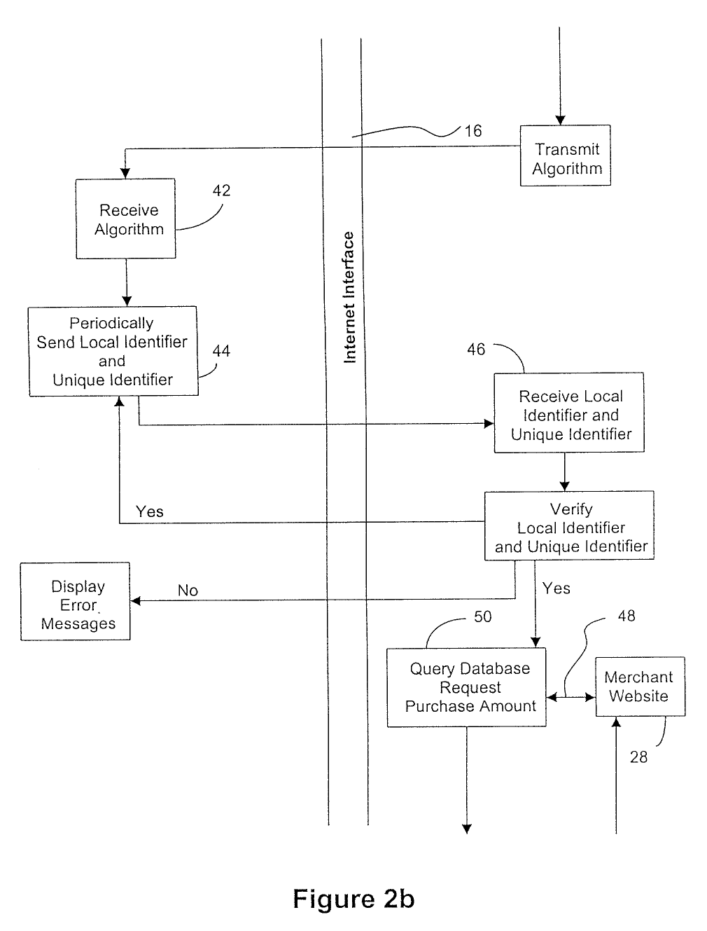

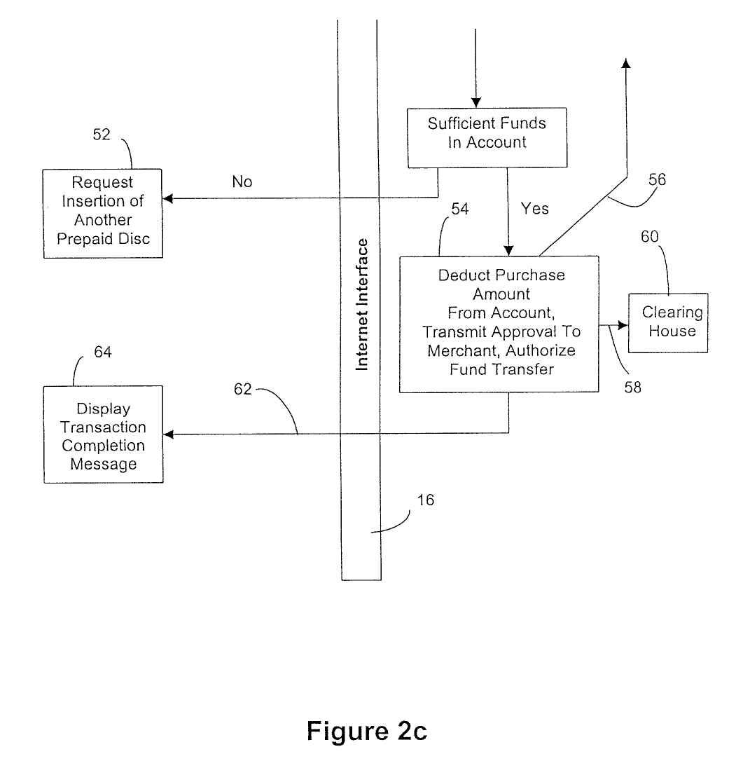

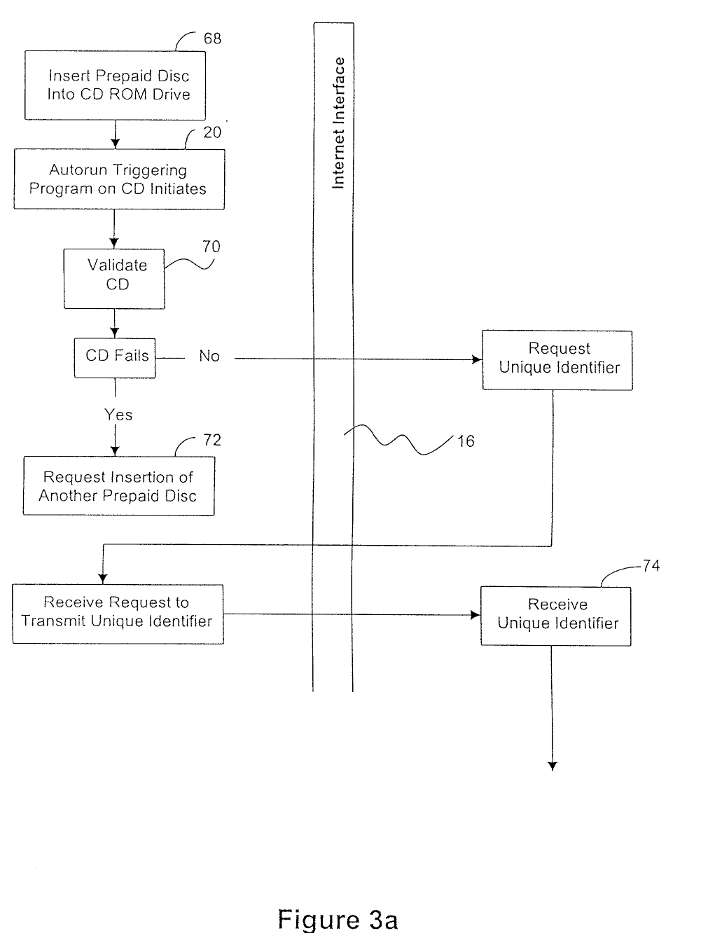

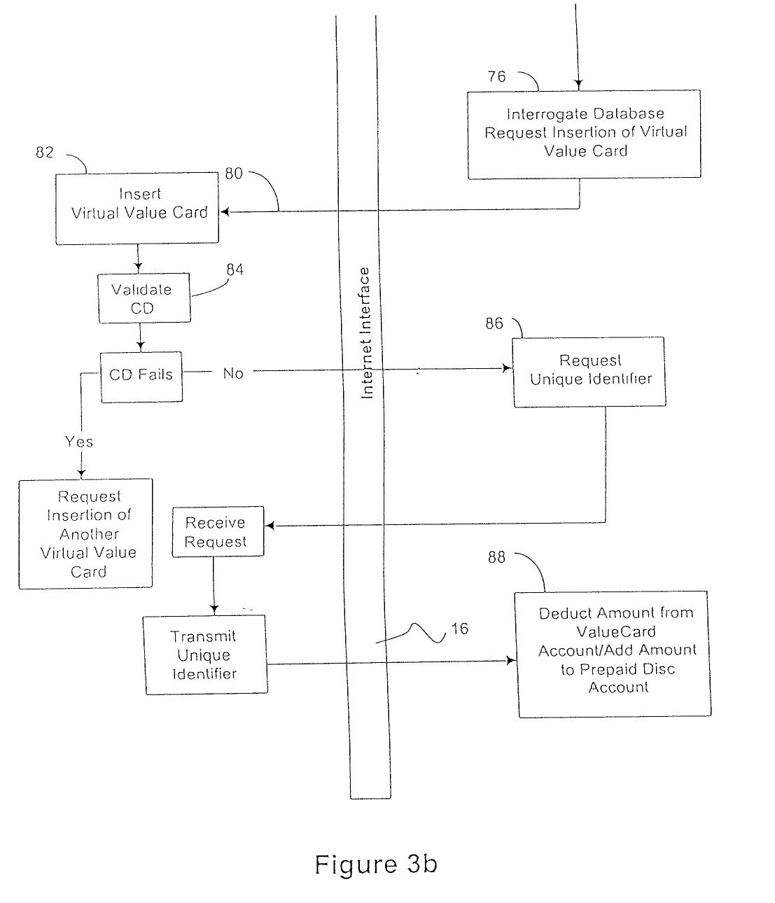

### DETAILED DESCRIPTION OF THE PREFERRED EMBODIMENT

A prepaid transaction settlement system 10 in accordance with the invention utilizes an optical disc 12, such as a cd-rom, and a remote memory, prepaid account platform 14 to allow a user to settle a purchasing transaction while shopping on-line on the Internet 16.

Each optical disc 12 has a unique identifier 18 associated with it and recorded thereon. Software 20, including security software for preventing misuse of the disc 12, is also recorded on each prepaid optical disc. The database 22 maintained on the prepaid account platform 14 has a record for each prepaid optical disc 12 which includes fields containing the identifier 18 and the prepaid monetary amount 24 associated with the optical disc 12. The prepaid optical discs 12 may be purchased through various distribution channels 26. For example, the user may purchase a prepaid optical disc 12 at a typical retail outlet such as a convenience store, a gas station, a supermarket, or a bank. Other distribution channels 26 such as direct mailing may also be used. The upper surface of the prepaid optical disc 12 may have printed thereon information about the issuer of the disc 12, the prepaid value associated with the disc, and/or the retail source of the disc 12.

In the preferred embodiment, the prepaid optical disc 12 and the prepaid account platform 14 are used as a means of payment for goods or services purchased online over the Internet 1 6. Conventionally, the online purveyor's website 28 includes one or more payment pages which must be filled out with credit card information by a purchaser to effect payment for his purchase. A website 28 may now provide the purchaser with a choice of paying by conventional credit card or by means of a prepaid optical disc 12 and prepaid account platform 14 in accordance with the subject invention. Upon selecting payment via a prepaid disc 12, the online purveyor's website 28 will prompt the purchaser to insert the prepaid optical disc 12 into the cd rom drive of his computer 30. If the prepaid disc 12 is not inserted into the cd rom drive within a pre-determined time-out period, the transaction is automatically terminated.

Once a prepaid disc 12 is inserted 32 into the cd rom drive, an autorun program 20 stored on the prepaid disc 12 initiates a validity check 36 of the disc 12, checking the structure of the prepaid disc, and displays a status message at the computer 30 informing the purchaser that verification of the disc has been initiated. If the disc 12 is invalid, an error message is displayed 38 on the purchaser's computer 30 requesting insertion of a valid prepaid disc 12. If the disc is valid, the prepaid disc software 20 establishes communication 34 with the central prepaid account platform 14. Preferably, such communication will utilize a secure communication channel, such as SSL or the like, so that the data flowing between the purchaser's computer 30 and the prepaid account platform 14 is encrypted. The software 20 then requests 40 the prepaid account platform 14 to provide algorithm information. When the algorithm information is received 42 from the prepaid account platform 14, the location identifier and the unique identifier 18 associated with the prepaid disc 12 are transmitted 44 back to the prepaid account platform 14.

Upon receipt 46 of the identifier 18, the prepaid account platform 14 queries 48 the online purveyor website 28 for the amount of the purchase and interrogates 50 its database 22 to determine the prepaid amount 24 associated with the prepaid disc 12. If the prepaid amount 24 is not sufficient to cover the purchase amount, the purchaser is requested 52 to insert another prepaid disc 12 into the cd rom drive. If another prepaid disc 12 is not inserted within a predetermined period of time, the transaction is terminated.

If the prepaid account associated with the prepaid disc has sufficient funds, the central prepaid account platform 14 deducts 54 the value of the transaction from the prepaid amount 24, transmits 56 an approval code to the online purveyor 28, and transmits 58 a transfer instruction to a financial clearing house 60, such as a bank, authorizing transfer of funds in the amount of the transaction to the online purveyor 28. Finally, the prepaid account platform transmits 62 a message 64 to the purchaser indicating that the transaction has been completed successfully and providing the remaining value of the prepaid account.

A prepaid optical disc 12 in accordance with the invention may also be recharged by making deposits into the prepaid account associated with the prepaid disc 12. In a preferred embodiment, a user will purchase a virtual value card 66 in substantially the same manner that is used to purchase the prepaid optical disc 12. That is, the virtual value cards 66 and prepaid optical discs 12 are preferably distributed through the same channels.

Each virtual value card 66 is an optical disc having a unique identifier 18′ associated with it and recorded thereon. The database maintained on prepaid account platform 14 has a record for each virtual value card which includes fields containing the identifier 18′ and the prepaid amount associated with the card 66. To recharge a prepaid optical disc 12, the user connects his computer to the Internet and inserts 68 the prepaid disc 12 into the cd rom drive of his computer 30. The software 20 stored on the prepaid disc 12 initiates a validity check 70 of the prepaid disc 12. If the prepaid disc 12 is invalid, an error message 72 is displayed on the purchaser's computer 30 requesting that a valid prepaid disc 12 be inserted. Alternatively, the transaction may be terminated. If the prepaid disc 12 is valid, the software 20 establishes communication with the central prepaid account platform 14 via a secure communication channel. The prepaid account platform 14 then requests the unique identifier 18 associated with the prepaid disc 12.

Upon receipt 74 of the identifier 18, the prepaid account platform 14 interrogates 76 its database 22 to determine the prepaid amount 78 associated with the prepaid disc 12 and transmits 80 a message to the user's computer instructing the user to insert 82 the virtual value card 66. The prepaid account platform 14 then authenticates 84 the virtual value card 66 in the manner described above and upon determining that the virtual value card 66 is valid, requests 86 the unique identifier 18′ associated with the virtual value card. Upon receipt of the identifier 18′ , the prepaid amount 78 associated with the virtual value card 66 is deducted 88 from the database record of the virtual value card 66 and added to the database record of the prepaid disc 12. Alternatively, the virtual value card 66 may be inserted before the prepaid disc 12, with the associated validity check and data download being performed as described above.

The database record associated with a particular prepaid optical disc 12 may also contain fields for storing other information associated with the disc 12 and/or its use. For example, the prepaid account platform may request and receive online purveyor identification information and/or information on the goods and services which are purchased with the disc 12. Such information can be used for bonus point redemption schemes which provide awards based on the volume or value of purchases. The information can also be used to collect marketing data.

It should be appreciated that the present invention applies to virtually any type of prepaid application utilizing an optical disc.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A system for settling an online purchase made via an Internet connection between a purchaser's computer and an online purveyor, the system comprising:
a central account platform adapted for connection to the Internet, the account platform including a database having a plurality of prepaid account records, each of the prepaid account records including a unique prepaid account identifier and a monetary amount associated with the prepaid account identifier; and
a prepaid optical disc adapted for use in a cd rom drive of the purchaser's computer, the disc having one of the prepaid account identifiers and software recorded thereon, the software including means for initiating communication between the account platform and the purchaser's computer.

2. The system of claim 1 wherein the database of the account platform also has a plurality of virtual value records, each of the virtual value records including a unique virtual value account identifier and a monetary amount associated with the virtual value account identifier.

3. The system of claim 2 further comprising a virtual value card adapted for use in the cd rom drive of the purchaser's computer, the card having one of the virtual value account identifiers and software recorded thereon, the software including means for initiating communication between the account platform and the purchaser's computer.

4. A method of settling an online purchase made by a purchaser via an Internet connection between the purchaser's computer and an online purveyor utilizing a central account platform and a prepaid optical disc, the account platform including a database having a plurality of prepaid account records, each of the prepaid account records including a unique prepaid account identifier and a monetary amount associated with the prepaid account identifier, the prepaid optical disc having one of the prepaid account identifiers and software recorded thereon, the software including an autorun program, the method comprising the steps of:
initiating communication between the purchaser's computer and the account platform;
transmitting the prepaid account identifier stored on the prepaid optical disc to the account platform;
verifying account and purchase information at the account platform; and
settling the purchase from the account platform if the monetary amount associated with the prepaid account identifier is equal to or greater than the amount of the purchase.

5. The method of claim 4 wherein the step of initiating communication includes the substeps of:
a) sending a request from the online purveyor to the purchaser's computer that the purchaser select a method of payment;
b) inserting the prepaid optical disc into the purchaser's computer in response to the message; and
d) initiating communication from the purchaser's computer to the account platform with the autorun program.

6. The method of claim 5 wherein the step of initiating communication also includes the substeps of:
e) performing a validity check of the prepaid optical disc from the account platform;
f) transmitting a request from the purchaser's computer to the account platform for a algorithm information; and
g) receiving the algorithm information from the account platform at the purchaser's computer.

7. The method of claim 4 wherein the step of transmitting the prepaid account identifier includes the substeps of:
a) transmitting the prepaid account identifier and local identifier from the purchaser's computer to the account platform; and
b) verifying the prepaid account identifier and local identifier at the account platform.

8. The method of claim 4 wherein the step of verifying account and purchase information includes the substeps of:
a) interrogating the database to determine the monetary amount associated with the prepaid account identifier received from the purchaser's computer;
b) querying the online purveyor for the amount of the purchase; and
c) comparing the monetary amount associated with the prepaid account identifier to the amount of the purchase.

9. The method of claim 8 wherein the step of verifying account and purchase information also includes the steps of:
d) transmitting a message from the account platform to the purchaser's computer to insert another prepaid optical disc if the monetary amount associated with the prepaid account identifier is less than the amount of the purchase;
e) interrogating the database to determine the monetary amount associated with the prepaid account identifier received from the purchaser's computer; and
f) comparing the monetary amount associated with the prepaid account identifier to the amount of the purchase.

10. The method of claim 4 wherein the step of settling the purchase includes the substep of transmitting an approval code to the online purveyor.

11. The method of claim 1 0 wherein the step of settling the purchase also includes the substeps of:
deducting the amount of the purchase from the monetary amount associated with the prepaid account identifier in the database; and
displaying a transaction completed message on the purchaser's computer.

12. The method of claim 11 wherein the step of settling the purchase also includes the substep of transmitting authorization from the account platform to a financial clearing house to transfer funds to the online purveyor.

13. The method of claim 4 wherein the database of the account platform also includes a plurality of virtual value account records, each of the virtual value account records including a unique value account identifier and a monetary amount associated with the value account identifier and the method further comprises the step of increasing the monetary amount associated with the prepaid account identifier.

14. The method of claim 13 wherein the step of increasing the monetary amount includes the substeps of:
a) inserting a virtual value card having one of the virtual value account identifiers and software recorded thereon into the purchaser's computer;
b) transmitting account information to the account platform; and
c) adding the monetary amount associated with the value account identifier to the monetary amount associated with a prepaid account identifier.

15. The method of claim 14 wherein step a) includes performing a validity check of the virtual value card.

16. The method of claim 14 wherein the following steps are performed before step a):
i) inserting a prepaid optical disc into the purchaser's computer; and
ii) transmitting the prepaid account identifier stored on the prepaid optical disc to the account platform.

17. The method of claim 14 wherein step c) includes the substeps of:
i) interrogating the database to determine the monetary amount associated with the virtual value account identifier received from the purchaser's computer;
ii) adding the monetary amount associated with the virtual value card identifier to the monetary amount associated with the prepaid account identifier; and
iii) zeroing the monetary amount associated with the virtual value account identifier.

18. The method of claim 14 wherein step b) includes transmitting the virtual value account identifier stored on the virtual value card to the account platform.

19. The method of claim 1 6 further including the step of iii) performing a validity check of the prepaid optical disc.
